(19) United States
(12) Patent Application Publication
(10) Pub. No.: US 2024/0057070 A1
(43) Pub. Date: Feb. 15, 2024

(54) METHOD AND APPARATUS FOR SIDELINK COMMUNICATION

(71) Applicant: Samsung Electronics Co., Ltd., Suwon-si (KR)

(72) Inventors: Miao ZHOU, Beijing (CN); Feifei SUN, Beijing (CN); Min WU, Beijing (CN)

(21) Appl. No.: 18/447,590

(22) Filed: Aug. 10, 2023

(30) Foreign Application Priority Data
Aug. 10, 2022 (CN) 202210956609.0

(51) Int. Cl. H04W 72/1263; H04W 72/25; H04W 72/52

(52) U.S. Cl. CPC H04W 72/1263; H04W 72/25; H04W 72/52

(57) ABSTRACT

The disclosure relates to a fifth generation (5G) or sixth generation (6G) communication system for supporting a higher data transmission rate. A method performed by a user equipment (UE) in a wireless communication system is provided. The method includes identifying information on a first sidelink (SL) communication of a first communication scheme and performing resource allocation of a second SL communication of a second communication scheme based on the information on the first SL communication. The first SL communication scheme is different from the second SL communication scheme.

### CROSS-REFERENCE TO RELATED APPLICATION(S)

This application is based on and claims priority under 35 U.S.C. § 119(a) of a Chinese patent application number 202210956609.0, filed on Aug. 10, 2022, in the Chinese Intellectual Property Office, the disclosure of which is incorporated by reference herein in its entirety.

### BACKGROUND

### 1. Field

The disclosure relates to the wireless communication system. More particularly, the disclosure relates to a method and an apparatus for a sidelink (SL) communication.

### 2. Description of Related Art

Fifth generation (5G) mobile communication technologies define broad frequency bands such that high transmission rates and new services are possible, and can be implemented not only in “Sub gigahertz (6 GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input and multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for a sidelink (SL) communication.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes identifying information on a first sidelink (SL) communication of a first communication scheme and performing resource allocation of a second SL communication of a second communication scheme based on the information on the first SL communication. The first SL communication scheme is different from the second SL communication scheme.

In accordance with another aspect of the disclosure, a UE in a wireless communication system is provided. The UE includes a transceiver including a first communication circuit and a second communication circuit and at least one processor (or, controller) coupled with the transceiver and configured to identify information on an SL communication of a first communication scheme and perform resource allocation of a second SL communication of a second communication scheme based on the information on the first SL communication. The first SL communication scheme is different from the second SL communication scheme.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a schematic diagram of a wireless network according to an embodiment of the disclosure;

FIGS. 2A and 2B illustrate a wireless transmission and reception paths according to various embodiments of the disclosure;

FIG. 3A illustrates a user equipment (UE) according to an embodiment of the disclosure;

FIG. 3B illustrates a gNodeB (gNB) according to an embodiment of the disclosure;

FIG. 4 illustrates a flowchart of a method for sidelink communication according to an embodiment of the disclosure;

FIG. 5 illustrates a flowchart of a method for sidelink communication according to an embodiment of the disclosure;

FIG. 6 illustrates a block diagram of a configuration of a UE according to an embodiment of the disclosure; and

FIG. 7 illustrates a block diagram of a configuration of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms, such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

In order to meet the increasing demand for wireless data communication services since the deployment of fourth generation (4G) communication systems, efforts have been made to develop improved 5G or pre-5G communication systems. Therefore, 5G or pre-5G communication systems are also called “beyond 4G networks” or “post-long term evolution (LTE) systems”.

In order to achieve a higher data rate, 5G communication systems are implemented in higher frequency (millimeter wave (mmWave)) bands, e.g., 60 GHz bands. In order to reduce propagation loss of radio waves and increase a transmission distance, technologies, such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, or the like.

In 5G systems, hybrid frequency shift keying (FSK) and quadrature amplitude modulation (QAM) (FQAM) and sliding window superlocation coding (SWSC) as advanced coding modulation (ACM), and filter bank multicarrier (FBMC), non-orthogonal multiple access (NOMA) and sparse code multiple access (SCMA) as advanced access technologies have been developed.

According to some embodiments of the disclosure, a method for sidelink communication performed by a user equipment UE including a first module and a second module is provided, the method including providing, by the first module, first related information for sidelink communication to the second module, and/or acquiring, by the first module, second related information for sidelink communication from the second module, and performing at least one of the following procedures based on the first related information and/or the second related information resource determination, re-evaluation, pre-emption, and inter-UE coordination (IUC) information generation, wherein the first module corresponds to a first sidelink communication system and the second module corresponds to a second sidelink communication system.

In some implementations, the method further includes providing, by the first module, the first related information for sidelink communication to the second module, and/or acquiring, by the first module, the second related information from the second module, when at least one of the following conditions is satisfied the first module receiving a request from the second module, the first module being set to periodically provide the first related information to the second module, and/or the first module being set to periodically acquire the second related information from the second module, a channel busy rate channel busy rate (CBR) of a sidelink resource pool of the first module being within a threshold range, a priority of a physical sidelink shared channel (PSSCH) transmitted and/or expected to be transmitted by the first module being within a threshold range, the first module having a PSSCH that is required to be transmitted, the first module being triggered to perform re-evaluation and/or pre-emption of resources, a number of candidate resources in a generated candidate resource set being within a threshold range in a PSSCH resource determination procedure of the first module, the first module being required to generate IUC information, the first module detecting a conflict, PSSCH transmission by the first module being failed, a number of PSSCH retransmissions by the first module exceeding a threshold, and the first module failing to receive a PSSCH, and/or the first module transmitting a negative acknowledgement (NACK).

In some implementations, the acquiring of the second related information by the first module from the second module comprises transmitting a request by the first module to the second module to acquire the second related information.

In some implementations, when the first module acquires the second related information from the second module, the at least one condition is used to determine whether to perform the at least one procedure based on the second related information.

In some implementations, the first related information and the second related information include at least one of: content in at least one detected sidelink control information (SCI) format, reference signal received power (RSRP) of at least one SCI format and/or PSSCH, received signal strength indicator (RSSI) on at least one time-domain and/or frequency-domain resource, at least one resource selected in the resource determination procedure and/or the IUC information generation procedure, at least one resource excluded in the resource determination procedure and/or the IUC information generation procedure, and time-domain and/or frequency-domain resources selected for transmitting the sidelink communication.

In some implementations, the first module is one of a long-term evolution (LTE) sidelink (SL) module and a new radio NR SL module, and the second module is the other of the LTE SL module and the NR SL module.

According to some embodiments of the disclosure, a method for sidelink communication performed by a user equipment UE including a first module is provided, the method including requesting to acquire a configuration or pre-configuration related to a second sidelink communication system from a base station, acquiring the configuration or pre-configuration related to the second sidelink communication system from the base station, and monitoring, by the first module, sidelink communication in the second sidelink communication system based on the configuration or pre-configuration, wherein the first module corresponds to a first sidelink communication system different from the second sidelink communication system.

In some implementations, the requesting includes reporting a UE capability to the base station, and the UE capability includes a capability of cross-system monitoring.

In some implementations, the UE further includes a second module, and at least one of the following conditions is used for the first module to determine whether to monitor the sidelink communication in the second sidelink communication system the first module receiving a request from the second module, the first module being set to periodically provide the first related information to the second module, and/or the first module being set to periodically acquire the second related information from the second module, a channel busy rate CBR of a sidelink resource pool of the first module being within a threshold range, a priority of a physical sidelink shared channel (PSSCH) transmitted and/or expected to be transmitted by the first module being within a threshold range, the first module having a PSSCH that is required to be transmitted, the first module being triggered to perform re-evaluation and/or pre-emption of resources, a number of candidate resources in a generated candidate resource set being within a threshold range in a PSSCH resource determination procedure of the first module, the first module being required to generate IUC information, the first module detecting a conflict, PSSCH transmission by the first module being failed, a number of PSSCH retransmissions by the first module exceeding a threshold, and the first module failing to receive a PSSCH, and/or the first module transmitting a negative acknowledgement (NACK).

In some implementations, if the sidelink communication in the second sidelink communication system is monitored, a resource determination method of the first sidelink communication system is used and/or a resource determination method of the second sidelink communication system is reused when a resource determination procedure of the first sidelink communication system is performed.

In some implementations, when the resource determination procedure of the first sidelink communication system is performed, for a detection result from the first sidelink communication system and a detection result from the second sidelink communication system, different reference signal received power (RSRP) thresholds are used.

In some implementations, when the resource determination procedure of the first sidelink communication system is performed, for a detection result from the first sidelink communication system and a detection result from the second sidelink communication system, different physical layer priorities are used to determine an RSRP threshold.

In some implementations, the first module is one of a long-term evolution (LTE) sidelink (SL) module and a new radio NR SL module, and the second module is the other of the LTE SL module and the NR SL module.

In some implementations, the method further includes requesting, by the first module, resources from the base station periodically, which are used to report detected related information in the second sidelink communication system.

In some implementations, the at least one condition is used for the first module to determine whether to trigger reporting of related information in the second sidelink communication system to the base station, and/or for triggering the first module to request resources from the base station, wherein the resources are used to report detected related information in the second sidelink communication system.

In some implementations, the method further includes: after the first module acquires resources in the first sidelink communication system from the base station, if it is detected that a conflict occurs or will occur on the resources, reporting, by the first module, the conflict to the base station.

According to some embodiments of the disclosure, a method for sidelink communication performed by a base station is provided, the method including receiving a request for acquiring a configuration or pre-configuration related to a second sidelink communication system from a user equipment UE including a first module, and providing the configuration or pre-configuration related to the second sidelink communication system to the UE in response to the request, wherein the configuration or pre-configuration related to the second sidelink communication system is used to monitor sidelink communication in the second sidelink communication system, and wherein the first module corresponds to a first sidelink communication system different from the second sidelink communication system.

Some embodiments of the disclosure also provide a user equipment UE, including a transceiver configured to transmit and receive signals, and at least one processor (or, controller) coupled to the transceiver and configured to perform the aforementioned methods.

Some embodiments of the disclosure also provide a base station, including a transceiver configured to transmit and receive signals, and at least one processor (or, controller) coupled to the transceiver and configured to perform the aforementioned methods.

The disclosure provides a method for enabling different sidelink communication systems to dynamically coexist on the same channel, thereby improving the system performance of the sidelink communication system.

A method and a device for sidelink communication are disclosed, the method including providing, by the first module, first related information for sidelink communication to the second module, and/or acquiring, by the first module, second related information for sidelink communication from the second module, and performing at least one of the following procedures based on the first related information and/or the second related information resource determination, re-evaluation, pre-emption, and inter-UE coordination (IUC) information generation, wherein the first module corresponds to a first sidelink communication system and the second module corresponds to a second sidelink communication system. The disclosure provides a method for enabling different sidelink communication systems to dynamically coexist on the same channel, thereby improving the system performance of the sidelink communication system.

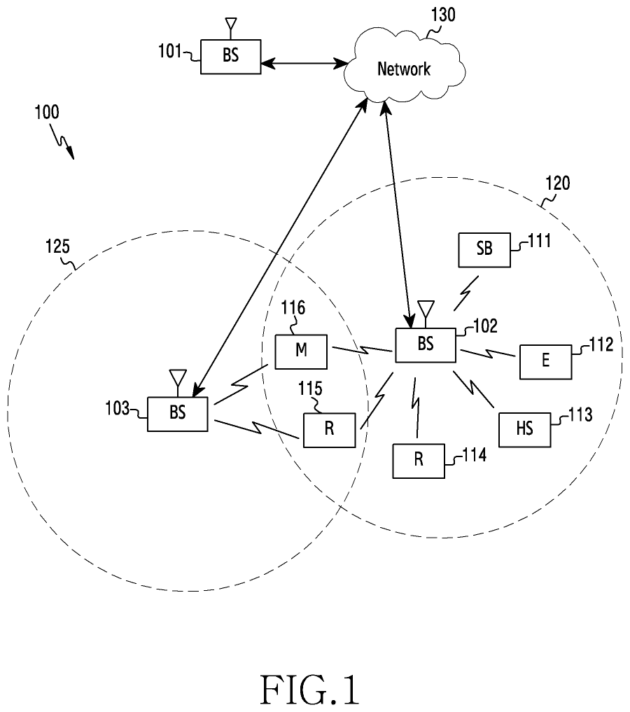

FIG. 1 illustrates a wireless network according to an embodiment of the disclosure.

Referring to FIG. 1, the embodiment of a wireless network 100 shown in FIG. 1 is for illustration only. Other embodiments of the wireless network 100 can be used without departing from the scope of the disclosure.

Referring to FIG. 1, the wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms, such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms, such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

According to an embodiment of the disclosure, gNB 102 may provide wireless broadband access to the network 130 for a first plurality of user equipments (UEs) within a coverage area 120 of gNB 102. The first plurality of UEs may include a UE 111, which may be located in a small business (SB), a UE 112, which may be located in an enterprise (E), a UE 113, which may be located in a wi-fi hotspot (HS), a UE 114, which may be located in a first residence (R), a UE 115, which may be located in a second residence (R), a UE 116, which may be a mobile device (M), such as a cellular phone, a wireless laptop computer, a wireless personal digital assistant (PDA), or the like. gNB 103 provides wireless broadband access to network 130 for a second plurality of UEs within a coverage area 125 of gNB 103. The second plurality of UEs include a UE 115 and a UE 116. In some embodiments of the disclosure, one or more of gNBs 101-103 can communicate with each other and with UEs 111-116 using 5G, long term evolution (LTE), long term evolution advanced (LTE-A), worldwide interoperability for microwave access (WiMAX) or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described below, one or more of gNB 101, gNB 102, and gNB 103 include a two dimensional (2D) antenna array as described in various embodiments of the disclosure. In some embodiments of the disclosure, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 may directly communicate with any number of UEs and provide wireless broadband access to the network 130 for those UEs. Similarly, each gNB 102-103 may directly communicate with the network 130 and provide direct wireless broadband access to the network 130 for the UEs. In addition, gNB 101, 102 and/or 103 may provide access to other or additional external networks, such as external telephone networks or other types of data networks.

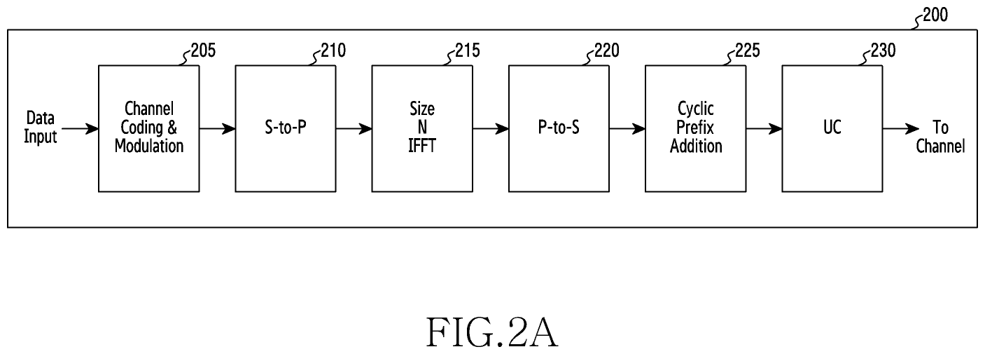

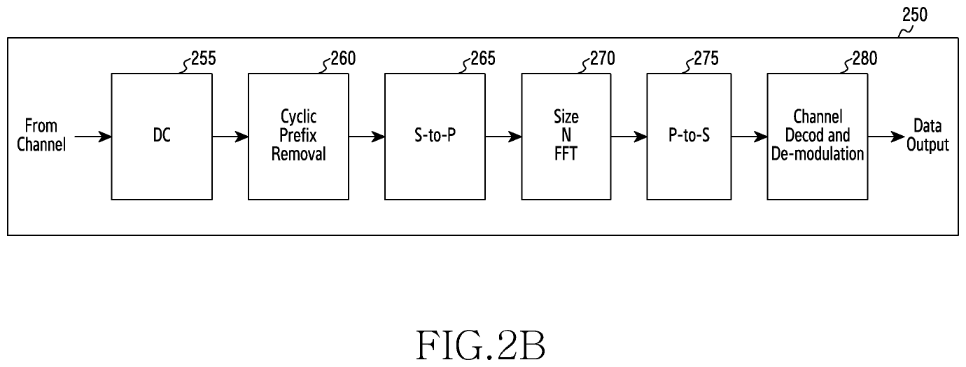

FIGS. 2A and 2B illustrate example wireless transmission and reception paths according to various embodiments of the disclosure.

Referring to FIG. 2A and FIG. 2B, a transmission path 200 may be described as being implemented or included in a gNB, such as gNB 102, and the reception path 250 may be described as being implemented or included in a UE, such as UE 116. However, it should be understood that the reception path 250 may be implemented in a gNB and the transmission path 200 may be implemented in a UE. In some embodiments of the disclosure, the reception path 250 is configured to support codebook designs and structures for systems with 2D antenna arrays as described in various embodiments of the disclosure.

Referring to FIGS. 2A and 2B, the transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

According to an embodiment of the disclosure, in the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The parallel-to-serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The Size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B may be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

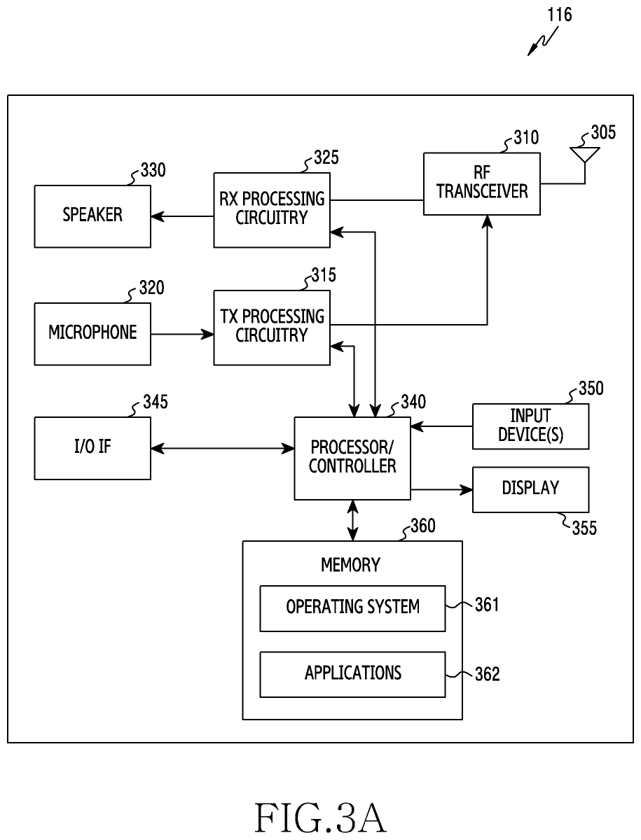

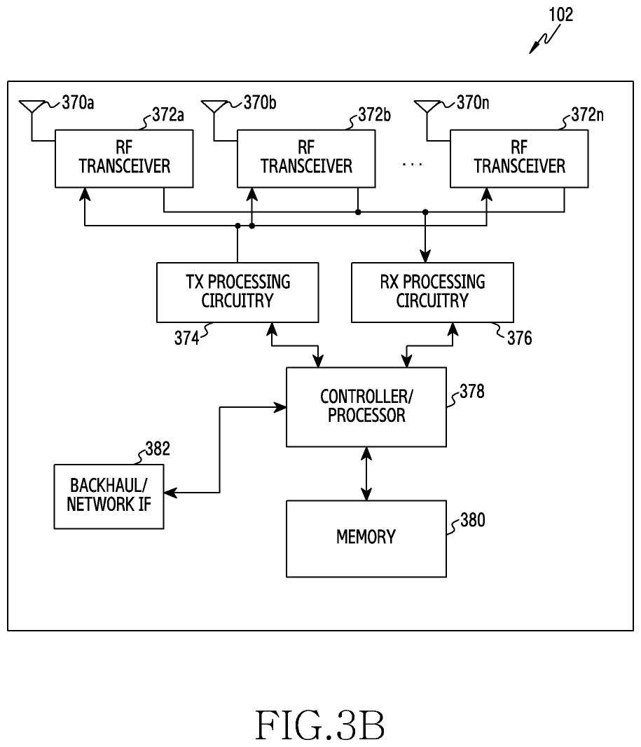

FIG. 3A illustrates an example UE 116 according to an embodiment of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

Referring to FIG. 3A, UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and/or a memory 360. The memory 360 includes an operating system (OS) 361 and one or more applications 362.

The RF transceiver 310 may receive an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 may receive analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments of the disclosure, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in various embodiments of the disclosure. The processor/controller 340 can move data into or out of the memory 360 as required by an execution process. In some embodiments of the disclosure, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices, such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to an embodiment of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments of the disclosure, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process, such as that performed through a BIS algorithm, and decode a received signal from which an interference signal is subtracted. A controller/processor 378 may support any of a variety of other functions in gNB 102. In some embodiments of the disclosure, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in various embodiments of the disclosure. In some embodiments of the disclosure, the controller/processor 378 supports communication between entities, such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments of the disclosure, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described below, the transmission and reception paths of gNB 102 (implemented using RF transceivers 372a-372n, TX processing circuit 374 and/or RX processing circuit 376) support aggregated communication with frequency division duplexing (FDD) cells and time division duplexing (TDD) cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In the long term evolution (LTE) technology, sidelink communication includes two main types of mechanisms including direct device to device (D2D) communication and vehicle to outside communication (vehicle to vehicle/infrastructure/pedestrian/network, collectively referred to as V2X), where the V2X communication is designed based on the D2D technology, is superior to the D2D in data rate, delay, reliability and link capacity, and is the most representative sidelink communication technology in LTE technology. In 5G systems, at present, sidelink communication mainly includes vehicle to outside (V2X) communication.

As the evolution technology of LTE, 5G NR systems also include the further evolution of sidelink communication accordingly. NR V2X technology was formulated in Release 16. As the evolution version of LTE V2X technology, NR V2X has superior performance in all aspects. In Release 17, 5G NR systems are expected to further expand the application scenarios of NR V2X to other broader application scenarios, e.g., commercial sidelink communication and public safety (PS) scenarios. In Release 18, the evolution of sidelink communication includes the direction of unlicensed frequency band, FR2, carrier aggregation, co-channel coexistence with LTE, or the like, and also includes the support for technologies in other fields, such as positioning.

In various embodiments of the application, information configured by a base station, information indicated by signaling, information configured by a higher layer, and pre-configured information include a set of configuration information, multiple sets of configuration information, where the UE selects a set of configuration information therefrom for use according to a predefined condition, a set of configuration information including multiple subsets, where the UE selects a subset therefrom for use according to a predefined condition.

In various embodiments of the application, “lower than a threshold” may also be replaced by “lower than or equal to a threshold”, “higher than a threshold” may also be replaced by “higher than or equal to a threshold”, “less than or equal to” may also be replaced by “less than”, and “larger than or equal to” may also be replaced by “larger than”, and vice versa.

In various embodiments of the application, a part of the technical schemes provided are specifically described based on the V2X system, but their application scenarios should not be limited to the V2X system in sidelink communication, but may also be applied to other sidelink transmission systems. For example, the design based on V2X sub-channels in the following embodiments may also be used for D2D sub-channels or other sub-channels for sidelink transmission. The V2X resource pool in the following embodiments may also be replaced by the D2D resource pool in other sidelink transmission systems, such as the D2D.

In various embodiments of the application, when a sidelink communication system is the V2X system, a terminal or UE may be various types of terminals or UEs, such as a vehicle, infrastructure, and pedestrian, or the like.

A base station in the specification may also be replaced by other nodes, such as sidelink nodes, and a specific example is an infrastructure UE in the sidelink system. Any mechanism applicable to the base station in the embodiment may also be similarly used in the scenario where the base station is replaced by other sidelink nodes, and the illustration will not be repeated.

A slot in the specification may also be replaced by a time unit, a candidate slot may also be replaced by a candidate time unit, and a candidate slot resource may also be replaced by a candidate time unit resource. The time unit includes a specific time length, such as several consecutive symbols.

A slot in the specification may be either a subframe or slot in a physical sense, or a subframe or slot in a logical sense. Specifically, the subframe or slot in the logical sense is a subframe or slot corresponding to a resource pool for sidelink communication. For example, in the V2X system, the resource pool is defined by a repeated bitmap mapped to a specific slot set, which may be all slots or all other slots except some specific slots (such as slots for transmitting an master information block (MIB)/system information block (SIB)). A slot indicated as “1” in the bitmap may be used for V2X transmission and belongs to slots corresponding to the V2X resource pool. A slot indicated as “0” cannot be used for V2X transmission and does not belong to slots corresponding to the V2X resource pool.

The difference between the subframes or slots in the physical sense or those in the logical sense is illustrated by a typical application scenario below: when calculating the time-domain gap between two specific channels/messages (e.g., a PSSCH carrying sidelink data and a physical sidelink feedback channel (PSFCH) carrying corresponding feedback information, or e.g., a PSCCH and a PSFCH), and it is assumed that the gap is N slots, if calculating subframes or slots in the physical sense, the N slots correspond to the absolute time length of N*x milliseconds in time domain, and x is the time length of a physical slot (subframe) under the numerology of the scenario, in milliseconds, otherwise, if calculating subframes or slots in the logical sense, taking a sidelink resource pool defined by a bitmap as an example, the intervals among the N slots correspond to N slots indicated as “1” in the bitmap, and the absolute time length of the interval varies with the specific configuration of the sidelink communication resource pool, rather than a fixed value.

Further, a slot in the specification may be a complete slot or several symbols corresponding to a sidelink communication in a slot. For example, when the sidelink communication is configured to be performed on the X1-X2-th symbols in each slot, in this scenario, a slot in the following embodiments refers to the X1-X2-th symbols in a slot, for another example, when the sidelink communication is configured to be transmitted in a mini-slot, in this scenario, a slot in the following embodiments refers to the mini-slot defined or configured in the sidelink system, rather than the slot in the NR system, for still another example, when the sidelink communication is configured as symbol-level transmission, in this scenario, a slot in the various embodiments may be replaced by a symbol, or may be replaced by N symbols which are time-domain granularity of the symbol-level transmission.

In order to make the purpose, technical schemes and advantages of the application more clear, the implementations of the application will be further described with reference to the accompanying drawings.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

In the LTE sidelink communication system and NR V2X system of Release 16, from the perspective of resource allocation, the 5G sidelink communication system includes two modes: a resource allocation mode (e.g., mode 1) based on base station scheduling and a resource allocation mode in which UE selects independently. In LTE D2D and LTE V2X systems, the resource allocation mode based on base station scheduling is referred to as mode 1 and mode 3 respectively, and the resource allocation mode (e.g., mode 2) in which UE selects independently is referred to as mode 2 and mode 4 respectively. In the NR V2X system, the resource allocation mode based on base station scheduling and the resource allocation mode in which UE selects independently are referred to as mode 1 and mode 2 respectively. In the specification, for the convenience of description, the resource allocation mode based on base station scheduling and the resource allocation mode in which UE selects independently are referred to as mode 1 and mode 2, respectively, according to the classification in NR.

Although there are differences in details between the resource allocation modes in LTE and NR, their core principles are similar. For resource allocation mode 1, a method for obtaining base station scheduling by a sidelink UE is to request resources from a base station through SR/BSR and receive sidelink resources allocated for the UE in sidelink grant signaling transmitted by the base station.

For resource allocation mode 2, a method for selecting resources by a sidelink UE independently is that the UE maintains monitoring and caching a sidelink resource pool, and before sidelink transmission that is required to be transmitted, determines a channel detection time window (or, channel sensing time window) and a resource selection time window according to a time range in which the sidelink transmission is expected to be transmitted, performs channel detection (or, channel sensing) in the channel detection time window, excludes sidelink resources reserved by other sidelink UEs in the resource selection time window according to a result of the channel detection (or, channel sensing), and randomly selects resources for sidelink transmission in sidelink resources not excluded in the resource selection time window.

In order to save spectrum efficiency and support normal operation of commercial devices with old release, it is necessary to introduce coexistence technology to reduce the mutual interference between different sidelink communication systems. The existing coexistence technology lacks flexibility, and it is difficult to dynamically adjust according to the actual use situation, which will cause a certain waste of resources. Therefore, it is necessary to improve the method of coexistence of different communication systems (e.g., LTE and NR) on the sidelink.

In the specification, for resource allocation mode 1 and mode 2, a method for coexistence when LTE and NR are deployed in a same channel is provided respectively.

### Embodiment 1

The embodiment is mainly used for resource allocation mode 2. In the embodiment of the disclosure, a first UE supporting sidelink communication is provided with an LTE SL module and an NR SL module. In order to avoid inter-system interference, the NR SL module acquires information in an LTE SL system from the LTE SL module, and performs resource allocation in an NR SL system based on the information, and/or, the LTE SL module acquires information in the NR SL system from the NR SL module, and performs resource allocation in the LTE SL system based on the information.

In the embodiment of the disclosure, a first module (or, first communication circuit) is one of the LTE SL module and the NR SL module, and a second module (or, second communication circuit) is the other of the LTE SL module and the NR SL module. The first module and the second module are usually implementation modules inside a same UE, so interaction thereof may be performed inside the UE instead of over the air.

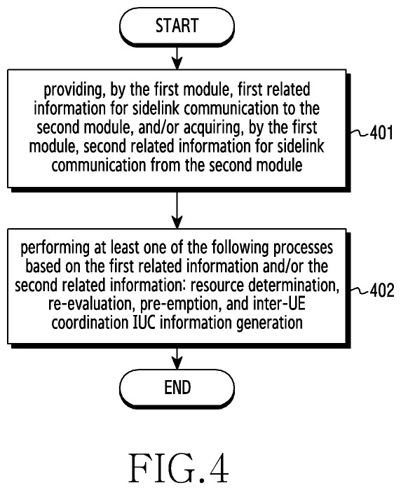

FIG. 4 illustrates a flowchart of a method for sidelink communication according to an embodiment of the disclosure.

Referring to FIG. 4, in operation 401, the first module of the UE provides related information for sidelink communication in a communication system of the first module to the second module, and/or the first module acquires related information for sidelink communication in a communication system of the second module, and in operation 402, may use it for at least one of the following of the first module: resource determination procedure, re-evaluation, pre-emption, and inter-UE coordination (IUC) information generation.

As another example, when at least one of the following conditions is satisfied, the first module provides the related information for sidelink communication in the communication system of the first module to the second module, and/or, the first module acquires the related information for sidelink communication in the communication system of the second module from the second module, and further includes that the first module transmits a request to the second module to acquire the related information for sidelink communication in the communication system of the second module

The following conditions is show below. (e.g., conditions 1)˜13))
1) receiving a request from the second module (the condition is only used as a condition for the first module to provide the related information for sidelink communication in the communication system of the first module to the second module),
2) being set to periodically provide the related information for sidelink communication in the communication system of the first module to the second module, and/or being set to periodically acquire the related information for sidelink communication in the communication system of the second module from the second module, and further, arriving at a set periodic time point;
3) a channel busy rate (CBR) of a sidelink resource pool of the first module being within a threshold range (for example, exceeding a preset threshold);
4) a priority of a physical sidelink shared channel (PSSCH) transmitted by the first module (including a PSSCH that is expected to be transmitted) being within a threshold range (for example, the priority exceeds a preset threshold, that is, a value of the priority is lower than the preset threshold);
5) the first module having a PSSCH that is required to be transmitted, and further, the first module being triggered by a higher layer to determine PSSCH resources, and/or the first module expecting that there is a PSSCH that is required to be transmitted within a preset time range, where the first module expecting that there is the PSSCH that is required to be transmitted may be based on parameters provided by a higher layer including a (non-zero) service period P_{rsxp_TX} in case that the first module is triggered by the higher layer to perform PSSCH resource determination;
6) the first module being triggered to perform re-evaluation and/or pre-emption of resources, alternatively, the condition is used only when the first module is the NR SL module;
7) a number of candidate resources in a generated candidate resource set being within a threshold range (for example, lower than a configured threshold), in the PSSCH resource determination procedure of the first module;
8) the first module being required to generate IUC information;
9) the first module detecting a conflict, where the conflict may be indicated in IUC information transmitted and/or received by the first module, and/or detected by decoding sidelink control information (SCI), and further, a number of detected conflicts (within a certain period of time) exceeding a threshold. Alternatively, an IUC-related condition is used only when the first module is the NR SL module;
10) PSSCH transmission by the first module being failed, where the failure may be determined by receiving a negative acknowledgement (NACK) or failing to receive acknowledgement (ACK), and further, a number of detected PSSCH transmission failures (within a certain period of time) exceeding a threshold. Alternatively, the condition is used only when the first module is the NR SL module;
11) a number of PSSCH retransmissions by the first module exceeding a threshold. Alternatively, the condition is used only when the first module is the NR SL module;
12) the first module failing to receive a PSSCH, and/or the first module transmitting NACK, and further, a number of times of failing to receive the PSSCH and/or transmitting the NACK (within a certain period of time) exceeding a threshold. Alternatively, the condition for transmitting the NACK is used only when the first module is the NR SL module.
13) The threshold/threshold range in the above method may be preset/pre-configured/configured by a higher layer/configured by a base station.

Alternatively, in case that the first module is the LTE SL module, the second module is the NR SL module, and at least one of the above conditions is satisfied, the first module provides the related information for sidelink communication in the communication system of the first module to the second module. Alternatively, when the first module is the NR SL module, the second module is the LTE SL module, and at least one of the above conditions is satisfied, the first module requests the related information for sidelink communication in the communication system of the second module from the second module.

According to an embodiment of the disclosure, the above conditions may also be used to determine whether the acquired information should be used in at least one of the resource determination procedure, re-evaluation, pre-emption, and/or IUC information generation procedure of the first module when the first module acquires the related information for sidelink communication in the communication system of the second module from the second module.

For example, in case that the second module is set to periodically provide the related information for sidelink communication in the communication system of the second module to the first module, and/or the first module is set to periodically acquire the related information for sidelink communication in the communication system of the second module from the second module, the first module may further determine or identify when to use the acquired information based on the above conditions.

As another example, the related information for sidelink communication in the communication system of the first/second module in the above method includes at least one of:
content in at least one detected SCI format, and further, locations, resource reservation periods and priorities of resources indicated in the detected SCI formats;
Reference signal received power (RSRP) of at least one SCI format and/or PSSCH;
Received signal strength indicator (RSSI) on at least one time-domain and/or frequency-domain resource;
at least one resource selected by the first/second module in the resource determination procedure and/or the IUC information generation procedure;
at least one resource excluded by the first/second module in the resource determination procedure and/or the IUC information generation procedure;
time-domain and/or frequency-domain resources selected by the first/second module for transmitting sidelink communication, for example, slots selected by the first module (expected to transmit) for transmitting the PSSCH. The information may be used to avoid a conflict caused by simultaneous transmission of LTE and NR. The conflict may be achieved by discarding one of LTE transmission and NR transmission, but if the information can be acquired, the conflict can be avoided by not selecting the conflicting resources.

As another example, in the above information, the information related to IUC is only applicable when a module corresponding to the information is the NR SL module.

As another example, the related information for sidelink communication further includes related information within a specific time range, which may be determined based on a time point when the first module provides the related information for sidelink communication in the communication system of the first module to the second module and/or the first module acquires the related information for sidelink communication in the communication system of the second module from the second module. For example, if the time point is slot n, the related information for sidelink communication includes related information in slots [n-a, n-b], where a corresponds to time-validity of the information (information that is too old may be invalid and does not need to be considered) and/or a range corresponding to information required for resource determination performed by a module that acquires the information, and b corresponds to a processing delay of the first module and/or the second module, and/or a range corresponding to information required for resource determination performed by a module that acquires the information. For the range corresponding to the information required for resource determination performed by the module that acquires the information, a specific example is that the first module performs the resource determination procedure in slot m, and acquires a detection result in [m-t1, m-t2] according to criterion requirement for detection, then n-a corresponds to m-t1, and/or n-b corresponds to m-t2.

As another example, in case that the first module (or, first circuit) acquires or obtain the above information from the second module (or, second circuit), there is an interval between a time point at which the information is acquired and a time point corresponding to at least one of being triggered to perform the resource determination procedure, being triggered to perform the re-evaluation and/or pre-emption, an earliest candidate resource in the resource determination procedure, a selected resource for transmitting the physical sidelink control channel (PSCCH) and/or PSSCH, and generating the IUC information, and the interval is within a threshold range (for example, exceeding a threshold corresponding to the processing delay of the UE). The threshold range may be based on UE capabilities.

In the above method, it is mentioned that information acquired from one communication system is used to generate IUC information in another communication system. The advantage of the method is that if there is a UE without an LTE module in the NR system, the NR UE cannot avoid interference from an LTE system through its own LTE module. At this time, other NR UEs with the LTE module can carry information in the LTE system in the IUC information to indicate it to the NR UE, so that the UE without the LTE module can avoid the interference of the LTE system by virtue of the IUC information.

### Embodiment 2

The embodiment is mainly used for resource allocation mode 2. In the embodiment of the disclosure, a first UE supporting sidelink communication has an NR SL module, and may not have an LTE SL module or may have an LTE SL module but the module cannot transmit information to the NR SL module. In order to avoid inter-system interference, the NR SL module monitors an LTE sidelink communication system, and determines NR transmission resources based on the monitoring of the LTE sidelink communication system (and monitoring of an NR communication system).

In case that the LTE SL module has a capability to monitor the NR communication system, the method can also be used in reverse, that is, the LTE SL module may monitor the NR sidelink communication system and determine or identify LTE transmission resources based on the monitoring of the NR sidelink communication system (and monitoring of the LTE communication system).

In the embodiment of the disclosure, for example, a first module is one of the LTE SL module and the NR SL module, and a second module is the other of the LTE SL module and the NR SL module. The first module and the second module are usually implementation modules inside a same UE, so interaction thereof may be performed inside the UE instead of over the air. That is, the first module and the second module include din the same UE are electrically connected via conductive connection member. For example, the first module and the second module are electrically connected via conductive lines and/or conductive vias which are formed on a printed circuit board on which the first module and the second module are disposed. At least one signal for information associated with the first module for the second module is transmitted or delivered from the first module to the second module (or, from the second module to the first module) via the conductive connection member.

As another example, the conductive connection member includes a C-clip, pogo-pin and/or FPCB (flexible printed circuit board).

Partial details in the following method are mainly illustrated by an example in which the NR SL module monitors the LTE system, but the method used may also be similarly used in the technology of monitoring the NR system by the LTE SL module.

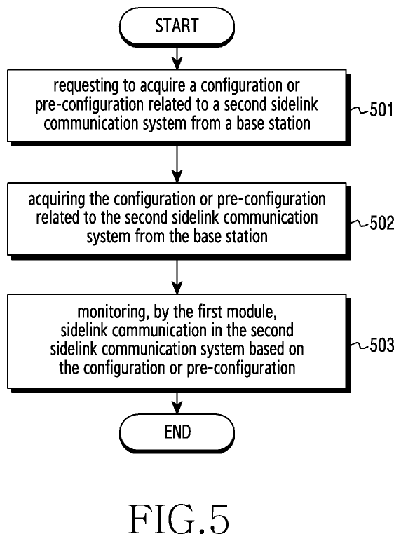

FIG. 5 illustrates another flowchart of a method for sidelink communication according to an embodiment of the disclosure.

Referring to FIG. 5, in operation 501 (or, step 501), the first module requests to acquire a (pre)configuration related to another sidelink communication system from a base station, including a configuration of a resource pool and/or a configuration related to sidelink communication specific to the first UE (or a first sidelink communication system). Alternatively, in operation 502 (or, step 502), the first module acquires the (pre)configuration related to another sidelink communication system from the base station. Alternatively, in operation 503 (or, step 503), the first module monitors sidelink communication in another sidelink communication system based on the acquired (pre)configuration related to the other sidelink communication system.

According to an embodiment of the disclosure, the request is realized by reporting UE capabilities to the base station, and the reported UE capabilities include a capability of cross-system monitoring. For example, the NR SL module reports to a gNB a capability of the NR SL module to monitor LTE sidelink communication, and the gNB is expected to provide a configuration for the LTE sidelink communication for the NR SL module.

According to an embodiment of the disclosure, if the NR SL module has a capability to monitor the LTE sidelink communication, the NR SL module always maintains monitoring the LTE sidelink communication, including maintaining the monitoring of the LTE sidelink communication in an NR resource pool. Alternatively, the monitoring of the LTE sidelink communication will only be performed when NR SL is not configured to be in a power-saving mode (for example, it is not configured to enable partial detection and/or random selection), or the monitoring of the LTE sidelink communication will always be maintained when NR SL is not configured to be in the power-saving mode. Alternatively, the conditions used in Embodiment 1 to determine whether the first module provides the related information for sidelink communication in the communication system of the first module to the second module, and/or whether the first module acquires the related information for sidelink communication in the communication system of the second module from the second module may also be used for the NR SL module to determine whether to monitor the LTE sidelink communication.

According to an embodiment of the disclosure, in case that the NR SL module monitors the LTE sidelink communication, when the resource determination procedure of NR is performed, not only the methods in the NR system can be used, including the method for detection based on a detection window (or, sensing window) of the NR system and/or the method for resource exclusion based on SCI decoding and an RSRP threshold in the NR system, but also the methods in the resource determination procedure in the LTE system can be reused, including the method for detection (or, sensing) based on a detection window of the LTE system, and/or the method for resource exclusion based on SCI decoding and an RSRP threshold in the LTE system, and/or the method for resource ordering based on RSSI measurement in the LTE system. Specifically, the methods in the protocols can be reused.

According to an embodiment of the disclosure, when the method for resource exclusion based on SCI decoding and an RSRP threshold, and/or the method for resource ordering based on RSSI measurement, and/or the method for detection based on a detection window described above are used, different RSRP thresholds are used for detection results from LTE (including SCI decoding results based on RSRP) and detection results from NR. In a specific example, for SCI with a same priority, when it is from LTE detection and NR detection, RSRP thresholds Th(pᵢ, pⱼ) used may be different, for example, they are configured by different RRC parameters respectively, or the threshold of LTE is the threshold configured by NR plus an offset. The advantage of the method is that since the LTE SL module is difficult to update in normal situations, the LTE communication is more likely not to avoid the interference in the NR system, while the NR communication can avoid the interference in the LTE system. Therefore, if the RSRP threshold from the LTE system is set lower, more SCI decoding results from LTE can be adopted in the resource selection process of NR SL, and more conflicts from LTE can be avoided.

Since the RSRP threshold is determined based on a priority, for example, in both NR and LTE, Th(pᵢ, pⱼ) is determined based on a priority in which the first UE transmit data by itself and a priority in which data from other UEs is received as two input parameters pᵢ, pⱼ, another method to achieve the above effect is to use different values of priorities for SCI from NR and LTE when calculating the RSRP threshold, and specifically, when the values of priorities indicated by SCI from NR and LTE respectively are the same, the values of priorities used to calculate the threshold of RSRP in corresponding systems respectively are different. For example, when a certain SCI is from the LTE detection, its priority for calculating the RSRP threshold is the value indicated in the SCI plus a (preset/configured) offset. For another example, when a certain SCI is from the LTE detection, there is a mapping relationship between its priority for calculating the RSRP threshold and the value of the priority indicated in its SCI, which may be preset or (pre)configured, for example, configured through a mapping table.

### Embodiment 3

The embodiment is mainly used for resource allocation mode 1. In the embodiment of the disclosure, a first UE supporting sidelink communication has an NR SL module, and may or may not have an LTE SL module. The NR SL module requests scheduling information of an LTE sidelink communication system from a base station, or reports detected related information in the LTE sidelink communication system.

In case that the LTE SL module can have corresponding capabilities, the method can also be used in reverse, that is, the LTE SL module requests scheduling information of an NR sidelink communication system from the base station, or reports detected related information in the NR sidelink communication system.

In the embodiment of the disclosure, a first module is one of the LTE SL module and the NR SL module, and a second module is the other of the LTE SL module and the NR SL module. Partial details in the following method are mainly illustrated by an example in which the NR SL module reports/requests LTE-related information to an NR base station, but the method used can also be similarly used in the technology in which the LTE SL module reports/requests NR-related information to an LTE base station.

According to an embodiment of the disclosure, the first module requests to acquire a (pre)configuration related to another sidelink communication system from the base station, including a configuration of a resource pool and/or a configuration related to sidelink communication specific to a first UE.

According to an embodiment of the disclosure, the first module reports the acquired related information in another sidelink communication system to the base station.

According to an embodiment of the disclosure, the request may be realized by reporting UE capabilities to the base station, and the reported UE capabilities include a capability of cross-system monitoring. Alternatively, the UE indirectly indicates that the UE can report the acquired related information in another sidelink communication system to the base station by reporting the UE capabilities to the base station.

According to an embodiment of the disclosure, the first UE periodically requests resources from the base station (for example, the resources may be requested by the first module of the first UE through SR/BSR), and the resources are used to report detected related information in another sidelink communication system (the specific information is similar to that in Embodiment 1).

According to an embodiment of the disclosure, the conditions used in Embodiment 1 to determine or identify whether the first module provides the related information for sidelink communication in the communication system of the first module to the second module, and/or whether the first module acquires the related information for sidelink communication in the communication system of the second module from the second module may also be used for the first UE to determine whether to trigger reporting of the related information in another sidelink communication system to the base station, and/or for triggering the first UE to request reporting resources from the base station.

According to an embodiment of the disclosure, after the first UE acquires the resources in the current sidelink communication system from the base station, if it detects that a conflict occurs (will occur) on the resources, the first UE reports the conflict to the base station. The UE expects that the report can trigger the base station to reselect resources scheduled to the first UE.

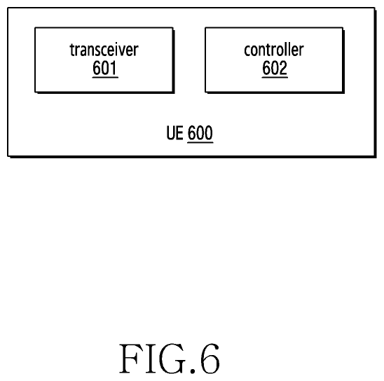

FIG. 6 illustrates a block diagram of a configuration of a user equipment (UE) according to an embodiment of the disclosure.

Referring to FIG. 6, a UE 600 according to various embodiments of the disclosure may include a transceiver 601, a controller 602 and/or memory. For example, the transceiver 601 may be configured to transmit and receive signals. For example, the controller 602 may be coupled to the transceiver 601 and configured to perform the aforementioned methods. The UE of FIG. 6 may correspond to the UE of FIG. 1 to FIG. 7.

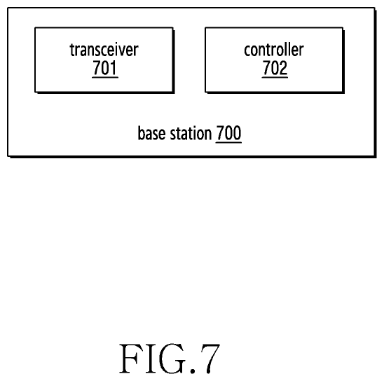

FIG. 7 illustrates a block diagram of a configuration of a base station according to an embodiment of the disclosure.

Referring to FIG. 7, a base station 700 according to various embodiments of the disclosure may include a transceiver 701, a controller 702 and/or memory. For example, the transceiver 701 may be configured to transmit and receive signals. For example, the controller 702 may be coupled to the transceiver 701 and configured to perform the aforementioned methods. The base station of FIG. 7 may correspond to the base station of FIGS. 1, 2A, 2B, 3A, 3B, and 4 to 7.

Although the UE and the base station are illustrated as having separate functional blocks for convenience of explanation, the configurations of the UE and the base station are not limited thereto. For example, the UE and the base station may include a communication unit including a transceiver and a controller. The UE and the base station may communicate with at least one network node by means of the communication unit.

A method performed by a user equipment (UE) in a wireless communication system is provided. The method comprises identifying information on a first sidelink (SL) communication of a first communication scheme and performing resource allocation of a second SL communication of a second communication scheme based on the information on the first SL communication. The first SL communication scheme is different from the second SL communication scheme.

The method further comprises monitoring the first SL communication via a first communication circuit for the first communication scheme and determining at least one for the first SL communication based on a result of monitoring the first SL communication.

The method further comprises transmitting, to a base station, a request message for scheduling information of the first SL communication, receiving, from the base station, information on a resource pool and configuration specific to the UE, performing the resource allocation of the second SL communication based on the information on the first SL communication.

The method further comprises identifying a channel busy rate (CBR) of the first SL communication and in case that the CBR of the first SL communication is more than a threshold, performing the resource allocation.

The method further comprises identifying that a conflict between the first SL communication and the second SL communication occurs, or a number of physical shared channel (PSSCH) retransmission exceeds a threshold, and in case that the conflict occurs or the number of PSSCH retransmission exceeds the threshold, performing the resource allocation of the second SL communication.

The information on the first SL communication includes at least one of sidelink control information (SCI) for the first SL communication, information on a reference signal received power (RSRP) of the first SL communication, or resources identified for the first SL communication.

The method further comprises transmitting, to a base station, a UE capability information including a UE capability of cross-system monitoring between the first SL communication and the second SL communication.

The first communication scheme corresponds to a long-term evolution (LTE) and the second communication scheme corresponds to a new radio (NR).

The method further comprises in case that a conflict between the first SL communication and the second SL communication occurs, transmitting, a base station, information indicating that the conflict occurs.

A user equipment (UE) in a wireless communication system is provided. The UE comprises a transceiver including a first communication circuit and a second communication circuit and at least one processor (or, a controller) coupled with the transceiver and configured to identify information on a first sidelink (SL) communication of a first communication scheme and perform resource allocation of a second SL communication of a second communication scheme based on the information on the first SL communication. The first SL communication scheme is different from the second SL communication scheme.

The at least one processor (or, controller) is further configured to monitor the first SL communication via the first communication circuit for the first communication scheme and determine at least one for the first SL communication based on a result of monitoring the first SL communication.

The at least one processor (or, controller) is further configured to transmit, to a base station, a request message for scheduling information of the first SL communication, receive, from the base station, information on a resource pool and configuration specific to the UE, and perform the resource allocation of the second SL communication based on the information on the first SL communication.

The at least one processor (or, controller) is further configured to identify a channel busy rate (CBR) of the first SL communication and in case that the CBR of the first SL communication is more than a threshold, perform the resource allocation.

The at least one processor (or, controller) is further configured to identify that a conflict between the first SL communication and the second SL communication occurs, or a number of physical shared channel (PSSCH) retransmission exceeds a threshold, and in case that the conflict occurs or the number of PSSCH retransmission exceeds the threshold, perform the resource allocation of the second SL communication.

The information on the first SL communication includes at least one of sidelink control information (SCI) for the first SL communication, information on a reference signal received power (RSRP) of the first SL communication, or resources identified for the first SL communication.

The at least one processor (or, controller) is further configured to transmit, to a base station, a UE capability information including a UE capability of cross-system monitoring between the first SL communication and the second SL communication.

The first communication scheme corresponds to a long-term evolution (LTE) and the second communication scheme corresponds to a new radio (NR).

The at least one processor (or, controller) is further configured to in case that a conflict between the first SL communication and the second SL communication occurs, transmit, a base station, information indicating that the conflict occurs.

The first communication circuit is configured to be set to periodically provide the first information to the second communication circuit or provide the first information to the second communication circuit in response to a request from the second communication circuit.

The at least one processor (or, controller) is further configured to receive, from the second communication circuit, a request for generating inter-UE coordination (IUC) information, and in response to receiving the IUC information, perform the resource allocation of the second SL communication.

According to various embodiments of the disclosure, at least a part of the UE and the base station (e.g., modules or their functions) or the methods (e.g., operations or steps) may be implemented as instructions stored in a computer-readable storage medium (e.g., a memory) in the form of program modules, for example. When executed by a processor or controller, the signalings may enable the processor or controller to perform corresponding functions. The computer-readable media may include, for example, hard disk, floppy disk, magnetic media, optical recording media, digital versatile disc (DVD), magneto-optical media. The signalings may include code created by a compiler or code executable by an interpreter. The module or UE according to various embodiments of the disclosure may include at least one or more of the above components, some of which may be omitted, or other additional components. Operations performed by modules, programming modules or other components according to various embodiments of the disclosure may be performed sequentially, in parallel, repeatedly or heuristically, or at least some operations may be performed in a different order or omitted, or other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
identifying information on a first sidelink (SL) communication of a first communication scheme; and
performing resource allocation of a second SL communication of a second communication scheme based on the information on the first SL communication,
wherein the first SL communication scheme is different from the second SL communication scheme.

2. The method of claim 1, further comprising:
monitoring the first SL communication via a first communication circuit for the first communication scheme; and
determining at least one for the first SL communication based on a result of monitoring the first SL communication.

3. The method of claim 1, further comprising:
transmitting, to a base station, a request message for scheduling information of the first SL communication;
receiving, from the base station, information on a resource pool and configuration specific to the UE; and
performing the resource allocation of the second SL communication based on the information on the first SL communication.

4. The method of claim 1, further comprising:
identifying a channel busy rate (CBR) of the first SL communication; and
in case that the CBR of the first SL communication is more than a threshold, performing the resource allocation.

5. The method of claim 1, further comprising:
identifying that a conflict between the first SL communication and the second SL communication occurs, or a number of physical shared channel (PSSCH) retransmission exceeds a threshold; and
in case that the conflict occurs or the number of PSSCH retransmission exceeds the threshold, performing the resource allocation of the second SL communication.

6. The method of claim 1, wherein the information on the first SL communication includes at least one of sidelink control information (SCI) for the first SL communication, information on a reference signal received power (RSRP) of the first SL communication, or resources identified for the first SL communication.

7. The method of claim 1, further comprising:
transmitting, to a base station, a UE capability information including a UE capability of cross-system monitoring between the first SL communication and the second SL communication.

8. The method of claim 1, wherein the first communication scheme corresponds to a long-term evolution (LTE) and the second communication scheme corresponds to a new radio (NR).

9. The method of claim 1, further comprising:
in case that a conflict between the first SL communication and the second SL communication occurs, transmitting, a base station, information indicating that the conflict occurs.

10. A user equipment (UE) in a wireless communication system, the UE comprising:
a transceiver including a first communication circuit and a second communication circuit; and
at least one processor coupled with the transceiver and configured to:
identify information on a first sidelink (SL) communication of a first communication scheme, and
perform resource allocation of a second SL communication of a second communication scheme based on the information on the first SL communication,
wherein the first SL communication scheme is different from the second SL communication scheme.

11. The UE of claim 10, wherein the at least one processor is further configured to:
monitor the first SL communication via the first communication circuit for the first communication scheme, and
determine at least one for the first SL communication based on a result of monitoring the first SL communication.

12. The UE of claim 10, wherein the at least one processor is further configured to:
transmit, to a base station, a request message for scheduling information of the first SL communication,
receive, from the base station, information on a resource pool and configuration specific to the UE, and
perform the resource allocation of the second SL communication based on the information on the first SL communication.

13. The UE of claim 10, wherein the at least one processor is further configured to:
identify a channel busy rate (CBR) of the first SL communication, and
in case that the CBR of the first SL communication is more than a threshold, perform the resource allocation.

14. The UE of claim 10, wherein the at least one processor is further configured to:
identify that a conflict between the first SL communication and the second SL communication occurs, or a number of physical shared channel (PSSCH) retransmission exceeds a threshold, and
in case that the conflict occurs or the number of PSSCH retransmission exceeds the threshold, perform the resource allocation of the second SL communication.

15. The UE of claim 10, wherein the information on the first SL communication includes at least one of sidelink control information (SCI) for the first SL communication, information on a reference signal received power (RSRP) of the first SL communication, or resources identified for the first SL communication.

16. The UE of claim 10, wherein the at least one processor is further configured to:
transmit, to a base station, a UE capability information including a UE capability of cross-system monitoring between the first SL communication and the second SL communication.

17. The UE of claim 10, wherein the first communication scheme corresponds to a long-term evolution (LTE) and the second communication scheme corresponds to a new radio (NR).

18. The UE of claim 10, wherein the at least one processor is further configured to:
in case that a conflict between the first SL communication and the second SL communication occurs, transmit, a base station, information indicating that the conflict occurs.

19. The UE of claim 10, wherein the first communication circuit is configured to:
be set to periodically provide the first information to the second communication circuit, or
provide the first information to the second communication circuit in response to a request from the second communication circuit.

20. The UE of claim 10, wherein the at least one processor is further configured to:
receive, from the second communication circuit, a request for generating inter-UE coordination (IUC) information, and
in response to receiving the IUC information, perform the resource allocation of the second SL communication.
